(19) United States
(12) Patent Application Publication
(10) Pub. No.: US 2003/0059017 A1
(43) Pub. Date: Mar. 27, 2003

(54) Method and system for controlling services during call establishment

(76) Inventors: Dusica Cugalj, Ottawa (CA); Eber Mello, Ottawa (CA); Steven Szeto, Kanata (CA); Tu Do, Kanata (CA)

Correspondence Address: MARKS & CLERK, 350 BURNHAMTHORPE ROAD WEST, SUITE 402, MISSISSAUGA, ON, L5B 3J1, CA

(21) Appl. No.: 09/957,670

(22) Filed: Sep. 21, 2001

(51) Int. Cl. H04M 3/42

(52) U.S. Cl. 379/211.01

(57) ABSTRACT

During call establishment through at least one call server, where at least one calling or called party owns at least one service which is to be invoked each time that a call involving that party is to be established, the following steps are carried out. (a) Any party who owns at least one service which is intended to monitor or control any call involving that party is required to register that service with a call server. (b) Establishing a list of controlling services, and inserting services into the list each time a specific call involving a specific party is being established, by first inserting into the list any service owned by the calling party, and then inserting into the same list any service owned by a called party. (c) Requiring the call server which is handling the call to visit each service in the list of controlling services in the order starting from the lastmost service inserted in the list; and if the then visited service is not invoked, then the call server will visit the next lastmost service. If a service is invoked, then each previously inserted service in the list is ignored, unless the invoked service permits otherwise.

### FIELD OF THE INVENTION

This invention relates to call establishment during the establishment of the telephone call on any kind of network capable of carrying telephone calls. The invention has particular utility in VOIP (voice over internet protocol) telephony. The invention is particularly directed to a method and system by which services logic interaction is controlled during call establishment.

### BACKGROUND OF THE INVENTION

The present invention contemplates a telephone network which may typically be a VOIP network which operates on the Internet, PSTN, and combinations of both. Within such network, there will be a plurality of users who may be a party to any call which is to be established. There will be at least one call server or there may be a plurality of call servers, and the purpose of the call servers is to provide various services to the users, as the users may subscribe. Typical services include determining the identity of a caller, and routing calls intended for one destination to another destination.

During the call establishment process, there may be many services on a call server, or on different call servers, that may be triggered and executed with regard to the same call which is being established. A very typical example is call forwarding, where user “A” calls user “B”, who forwards his calls to user “C”. User “C” may, in turn, forward his calls to user “D”. If so, then the services of users “B” and “C” will be executed during the same call.

Any call server or all call servers that are located on the network must enforce the execution of all services that are triggered by any call, as it is established, independently of the location of the call servers where those services reside. Further, the administration of the network must be such that the services are permitted to be distributed throughout the call servers on the network, without changing the expected behaviour of those services from the point of view of any user—that is, any party who subscribes to any of those services.

However, it is the responsibility of the call servers to manage bad interaction of services. For example, if user “A” forwards calls to user “B”, who forwards calls back to user “A”, the network must interfere to avoid an infinite loop, or call loop being established. That particular set of circumstances is described in a co-pending application, filed simultaneously herewith, Ser. No. ______.

Of more concern to the present invention, the network must also guarantee that any service will execute in an expected way, independently of the network path taken by any particular call. Again, for example, if user “A” wants to reject all calls that come from user “B”, and if user “B” calls user “C” who forwards calls to user “A”, then the service of user “A” must reject calls forwarded by user “C” when the original caller is still user “B”.

It is important to note that both the calling and the called parties in any call may have services on the network. It should also be noted that whenever a call server receives a call, it is usually the service of the calling party that is triggered to be executed first. Moreover, if that calling party's service is not located on the call server which has received the call, then the call must be sent to the call server that has the services for the calling party. Only after the calling party's services have been handled, may the services of a called party be invoked, independently of where on the network those services are located.

There is, of course, an exception to that rule. Specifically, emergency calls which are directed to 911 in North America must be processed in keeping with the destination address immediately.

It will also be noted that a calling party's service may reject a call, or route it to yet another destination. If so, than the services of the original called party will not be executed. Moreover, the services of the calling party may not terminate their execution during call establishment. Instead, the services of the calling party must be executing during the whole life of the call, even when any such service is active. In that case, both the services of the calling party as well of any called party will be executed in parallel—that is, contemporaneously—and they may eventually interact.

### SUMMARY OF THE INVENTION

To that end, the present invention provides both a method and a system for controlling services logic interaction during call establishment.

The method for controlling services logic interaction during call establishment through at least one call server, in keeping with the present invention, where at least one calling or called party owns at least one service which is to be invoked each time that a call involving that party is to be established, comprises the following steps:

a) Any party who owns at least one service which is intended to monitor or control any call involving that party is required to register that at least one service with a respective call server for that party.

b) A list of controlling services is established. Services are inserted into the list of controlling services each time a specific call involving a specific party is being established, by first inserting into that list any service owned by the calling party in the call being established, and then inserting into the same list any service owned by a called party in the call being established.

c) The at least one call server which is handling the call is required to visit each service in the list of controlling services in the order starting from the lastmost service inserted in the list, and if a service thus visited is not invoked then the call server will visit the next lastmost service inserted in the list. If a service thus visited is invoked, then each previously inserted service in the list is ignored, unless that then invoked service permits otherwise.

In keeping with the present invention, any service may be removed from a list of controlling services for an established call, in keeping with any one of the following steps:

d) Upon the explicit request by an existing controlling service.

e) Upon receipt by a service of a “call rejected” message with a specified reason. In that case, the service does not respond to the received “call rejected” message having the specified reason noted above.

f) Upon receipt by a specific service of a “call rejected” message with a specified reason of “no answer” following a predetermined period of time, the respective call server will remove that service from the list of controlling services, unless the service is willing to handle that message.

g) As stated in the paragraph immediately above, where other services have been added to the list of controlling services after the specific service, then those other services are also removed from the list of controlling services.

h) Upon cancellation of the call by the calling party thereof, in which case all services are removed from the list of controlling services for that call.

There may be a plurality of call servers interconnected by the network, and the list of controlling services may be distributed on the network among the plurality of call servers.

Also, there may be plurality of services that are executed contemporaneously during any call.

Moreover, any service that is owned by the calling party in a call is generally executed prior to any service owned by a called party to that call.

A further provision of the method of the present invention is that any service which is executed during the establishment of a call may be adapted to modify the flow of that call in keeping with any one of the following instructions:

i) Re-route the call to another address.

j) Reject the call according to any predetermined criterion.

k) Accept the call.

Another aspect of the present invention is to provide a system for controlling services logic interaction during call establishment through at least one call server on a network having a plurality of parties, wherein for any call to be established one of the plurality of parties is the calling party and at least one other of the plurality of parties is a called party. At least one of the calling party and the at least one called party will own at least one service which is to be invoked each time that a call involving that party is to be established.

The system comprises at least one call server onto which any party who is to be a party to a call to be established is required to register any service owned by that party, where the service is intended to monitor or control any call involving that party.

The system also includes a list establishing and maintaining means onto which a list of controlling services for any call being established is inserted.

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 illustrates a scenario where two users have registered services with a call server;

FIG. 2 illustrates a scenario where a call from a third user is routed to a fourth user; and

FIG. 3 illustrates another scenario similar to FIG. 2, but where the call is again re-routed to a fifth user.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

Before referring to the Figures of drawings, the principles of the present invention will be discussed.

First, it will be noted that there are several principal mechanisms that may be used by a service to modify the flow of a call during its establishment. They are as follows:

Re-Route the Call

The service which is running on a call server will modify the destination of the call so that it will be given to another address. However, the address may be the same address as that of the original destination of the call, possibly because some other information on the call—for example, the origination address—will make that service determine that it is no longer interested in the call. Another example may occur in that the service may be interested in taking over control of the call in the event that the call attempt to its original destination fails.

Reject

There may be a number of criteria that are screened for, in keeping with some screening policy, by which the service will issue a reject response to an incoming request to establish a call. Typical criteria include time of day, the identity of the caller, day of the week, and so on.

Accept

Of course, a service can determine that it will accept the incoming call request, and connect the caller to a Media Server.

The server may also monitor the progress of a call, and re-route the call, reject it, or accept it, based on what happens to that call. For example, a service can track how long the called user takes to accept the call request, or it can intercept an eventual message from the called user rejecting the call and try yet another destination on behalf of the caller.

Typically, a protocol which is based on Session Initiation Protocol (SIP) will be used between endpoints on the call, and call servers, and among the call servers themselves, in order to negotiate and establish calls. A basic call may use the following messages during its establishment:

Invite X (from A, to B)

This message may be sent by an endpoint, or a call server, to send or forward a call to another endpoint or call server. In this case, X is the destination of the call; A has originated the call; and B is the original destination of the call.

Call Rejected (Reason)

This is a message that is also sent by an endpoint or call server, as a response to an Invite message that has been received. The call rejected (reason) message provides the sender of the Invite a negative response which is related to the invitation; that is to say, the invited endpoint has rejected the invitation to join a call for the specific reason. A reason may be any one of a number of values, such as No Answer, or Busy.

It should be noted that the call server itself may generate the call rejected (reason) message, since the call server may decide or realize that the received Invite message should not or cannot be sent to the specified designation, either because a service on that Call Server interfered with the processing of the call or the Call Server itself decided to reject the call according to its internal rules. The call server may decide that after a given period of time, the call which is to be established may be considered to be “Not Answered”. In that case, the call server will cancel the call that is sent out to the called user, and will itself send a Call Rejected (No Answer) message to the calling user.

Call Accepted

Here, the message is sent out by an endpoint or the call server as a response to an Invite message that has been received. This message provides the sender of the Invite message a positive response which is related to the invitation; the invited endpoint is ready to exchange media.

Services that are running on different call servers will interact, using the protocol which has been described above. It may be assumed that all of the services run on different call servers, but typically at least some or all of the services may be running on the same call server. In any event, each call server will treat all services executing within itself as if those services resided on different call servers that are on the network.

This gives rise to the following rules which describe the procedures that the call server will follow to build, maintain, and control the listed services which control the call during its establishment.

Service Registration

A service can register with the call server for the Invite message it is interested in handling, either by specifying the caller or the called address present in that Invite message. Thus, all Invite messages within the criteria that are specified in the registration on the call server by that service will be given to the specified service for further instructions—which may be re-route, reject, or accept. The registration process will also allow a service to specify whether it wants to control the call if the call server receives the specified Invite message, or if it only wants to monitor the call without modifying its behaviour. In the latter case, the service will be notified of the call without having the capability to re-route, reject, or accept it. If the service is to issue a re-route request, then it may also specify which future messages (Call Accepted or Call Rejected) that is it interested in, and in which mode—monitoring or controlling. All services that are interested in controlling a call during its establishment will register with the call server for Call Accepted message, in the monitoring mode. As soon as the service is notified of that message, it will then request to be removed from the list of controlling services since it is no longer interested in that call.

Of course, it will be understood that whenever a service registered to control a call is inserted in the list of controlling services, then control of the call is given to that new service. If so, the processing of the call may be changed, in keeping with the requirements of that new service.

Inserting New Services

Each time a new service is invoked for execution, the call server must ensure that it will be inserted on the list controlling services that mimics the network order that the services would have had, in the event that they resided on different call servers. A new service is inserted into the list of call services which execute on a specific call, whenever a previous service controlling the call changes the destination address of the call to an address that has a service associated with it. If there are no services on the list, then the attempt to send an Invite message, either generated on the network or by a service, to a user that owns a service, will trigger the insertion of that service onto the list of controlling services.

The list of controlling services is maintained in the order in which the services are invoked, with the lastmost service in the list consequently being the most recent service that was invoked, and the first service on the list being the oldest service which is controlling the call.

Handling Messages from the Network

Whenever a message is received from the destination endpoint, or a call server, the respective call server will visit each service on the list of controlling services, starting from the lastmost service that was inserted in that list. If that lastmost service is registered to handle the message, then the message is given to the service, so that it has the opportunity to modify—that is, re-route, reject, or connect—the call. If the lastmost service handles the message, then the services previous to it will not be visited with the received message. Otherwise, if the lastmost service does not handle the message, then the next lastmost service will be visited, and so on. Of course, if a service which is visited is invoked then each previously inserted service on the list will be ignored unless the then invoked service permits otherwise.

Messages that are not handled by any of the services that are registered on the call server will be routed to the originating endpoint, particularly in the case of a traditional two-party call, or they will be handled by the call server itself in the event of a different type of call.

Removing Services

Services are removed from the list of controlling services in keeping with any one of the following steps.

(a) The service may explicitly request that it be removed from the list, which means that the service is no longer interested in controlling that call. For example, an auditing service that is “tracing” calls that are made to a busy or popular destination may decide that it will no longer trace any call once the destination has been connected, and therefore that service will request the call server to remove it from the list of controlling services.

If a controlling service requests to be removed from the list of controlling services, then the call server will proceed with processing of the call according to internal rules, either by routing the current message, if there is one, to the caller or called parties, or by giving control of the call to another service.

(b) If a service receives a Call Rejected message, with a specified reason, and the service does not handle the message, then that service will be removed from the list of controlling services.

(c) A service may receive a Call Rejected (No Answer) message that was internally generated by the call server. Of course, each service can specify a different value for “No Answer”, in other words a predetermined period of time in which the call should be answered can be established. The call server will remove that service after the predetermined time period has expired.

Moreover, any other services that have been added to the list of controlling services after the specific service, are also removed from the list of controlling services.

However, the recipient service will be given the opportunity to handle the Call Rejected (No Answer) message as if it had been received from the network.

(d) If the calling party itself cancels the call, then all services controlling the call are removed from the list of controlling services.

It will be understood, of course, that there may be a plurality of call services that are interconnected by a network, such as the internet, a PSTN, or combination; and a list of controlling services may be distributed on the network among the plurality of call servers.

Moreover, it has been noted that a plurality of services may be executed contemporaneously during any established call.

Referring now to the drawings, several scenarios are represented which, in effect, describe a sequence of events that may occur during the establishment of a call. In this case, it is assumed that the call will be intercepted by several services that reside on the same call server; and the creation and management of the list of controlling services will be discussed. The logic of all of these services is described below, where “A”, “B”, “X”, “Y”, and “Z” represent addresses of various users, and where “A” and “B” have services.

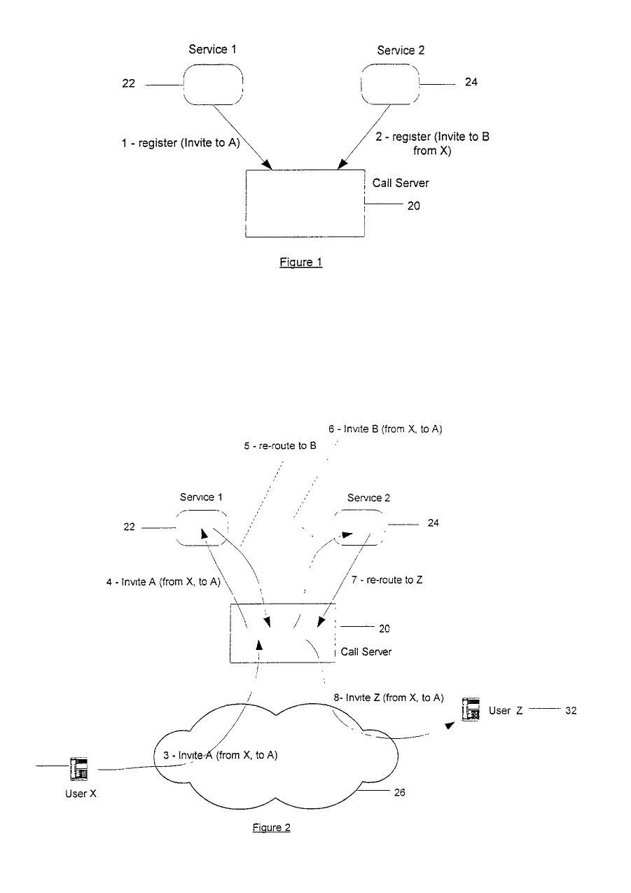

In FIGS. 1 to 3, the call server 20 has services 22 and 24, which are services that belong to users “A” and “B”, respectively, and as described hereafter. When a call is to be established, it will be through the network 26, and user X at 30, user Z at 32, and user Y at 34 will be the users who are involved in the call being established, at various steps throughout the call.

The definition of the Service 1 which is shown at 22, and which is owned by user A, is the following: “all calls to A must be forwarded to B; and if B does not answer, forward the call 20 to Y.

Service 2, which is represented at 24, is owned by user “B”, and is defined as follows: “all calls to B from X must be forwarded to Z”.

The various steps taken during the establishment of the call are numbered, and throughout FIGS. 1 to 3 there are 12 steps in all which are to be described below.

Referring now to FIG. 1, each of the services at 22 and 24 will register within the call server 20. Thus, calls to users “A” and “B” will be handled in keeping with the rules for the services as described above.

In the scenario which is shown in FIG. 1, there is no call which exists at this moment, and therefore the list of controlling services is empty.

Step 1 is simply a registration by user “A”, registering its service in the event that an Invite message is sent to that user. Step 2 is registration by user “B”, registering the service which must be invoked in the event that an Invite message is sent to user “B” from user “X”.

As stated, at this stage, the list of controlling services is empty.

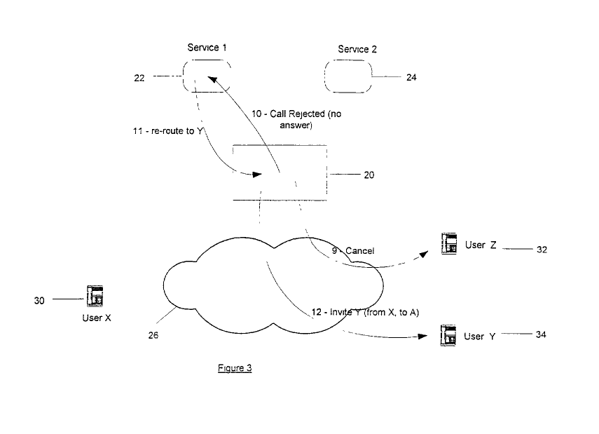

Now, referring to FIG. 2, user “X” calls user “A” in step 3, by sending an Invite message to user “A” (from X to A). The service of user “A” is invoked at step 4, and is inserted in the list of controlling services, which then becomes:

LCS={Service 1}.

Since the service of user “A” requires that the call must be re-routed to user “B”, and that the service is interested in Call Rejected (No Answer), then, step 5 takes place. The call server 20 will also trigger the service of user “B” in step 6 as—there is an Invite message to B (from X, to A).

Since the services of both users “A” and “B” from 22 and 24 are now running, as at steps 4 and 6, the list of controlling services is now as follows:

LCS={Service 1, Service 2}.

Thereafter, in keeping with the instructions of the service 2 as shown at 24, which is owned by user “B”, the call is re-routed to user “Z” in step 7. The call server 20 then routes the call to user “Z”, as shown in step 8, by sending the Invite message “Invite Z (from X, to A)”.

Finally, referring to FIG. 3, a scenario is established that user “Z” did not answer within a predetermined time period. Thus, at step 9, the call is cancelled, and Service 2 is removed from the list of controlling services. The list of controlling services is now as follows:

LCS={Service 1}.

At the same time, Service 1 is notified of the “No Answer” event that occurred at step 10, and Service 1 now re-routes the call to user “Y” at step 11. The call server 20 then routes the call to that user in step 12 by the message “Invite Y (from X, to A).

From the above, it will be seen that the present invention provides both a method and a system for controlling services logic interaction during call establishment. It will be understood, of course, that the list of controlling services for each call being established is maintained in appropriate memory which will be found within the call server 20 or a plurality of call servers, as the circumstances may require.

Other modifications and alterations may be used in the design and manufacture of the apparatus of the present invention without departing from the spirit and scope of the accompanying claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

Moreover, use of the terms “he”, “him”, or “his”, is not intended to be specifically directed to persons of the masculine gender, and could easily be read as “she”, “her”, or “hers”, respectively.

What is claimed is:

1. A method for controlling services logic interaction during call establishment through at least one call server, where at least one calling or called party owns at least one service which is to be invoked each time that a call involving that party is to be established, said method comprising the steps of:
(a) requiring any party who owns at least one service which is intended to monitor or control any call involving that party to register that at least one service with a respective call server for that party;
(b) establishing a list of controlling services into which services are to be inserted each time a specific call involving a specific party is being established, by first inserting into that list any service owned by the calling party in the call being established, and then inserting into that list any service owned by a called party in the call being established; and
(c) requiring the at least one call server to visit each service in the list of controlling services in the order starting from the lastmost service inserted in the list, and if a service thus visited is not invoked then to visit the next lastmost service inserted in the list; and if a service thus visited is invoked then to ignore each previously inserted service in that list unless the then invoked service permits otherwise.

2. The method of claim 1, wherein any service may be removed from the list of controlling services for an established call in keeping with any one of the following steps:
(d) upon the explicit request by an existing controlling service;
(e) upon receipt by a service of a “call rejected” message with a specified reason, and where the service does not respond to the received “call rejected” message having the specified reason;
(f) upon receipt by a specific service of a “call rejected” message with a specified reason of “no answer” following a predetermined period of time by the respective call server, unless the service is willing to handle that message;
(g) as stated in step (f), where other services have been added to the list of controlling services after said specific service, and where said other services are also removed from said list of controlling services; and
(h) upon cancellation of the call by the calling party thereof, whereby all services are removed from said list of controlling services.

3. The method of claim 1, wherein there are a plurality of call servers interconnected by a network, and said list of controlling services is distributed on said network among said plurality of call servers.

4. The method of claim 1, wherein a plurality of services is executed contemporaneously during any call.

5. The method of claim 1, wherein any service owned by the calling party in a call is executed prior to any service owned by a called party to that call.

6. The method of claim 1, wherein any service which is executed during the establishment of a call is adapted to modify the flow of that call in keeping with any one of the following instructions:
(i) re-route the call to another address;
(j) reject the call according to any predetermined criterion; and
(k) accept the call.

7. A system for controlling services logic interaction during call establishment through at least one call server on a network having a plurality of parties, wherein for any call to be established one of said plurality of parties is the calling party and at least one other of said plurality of parties is a called party, and wherein at least one of said calling party and said at least one called party owns at least one service which is to be invoked each time that a call involving that party is to be established, said system comprising:
at least one call server onto which any party who is to be a party to a call to be established is required to register any service owned by that party, where the service is intended to monitor or control any call involving that party; and
a list establishing and maintaining means onto which a list of controlling services for any call being established is inserted.

8. The system of claim 7, wherein there are a plurality of call servers interconnected by a network, and said list of controlling services is distributed on said network among said plurality of call servers.

9. The system of claim 7, wherein a plurality of services is executed contemporaneously during any established call.

10. The system of claim 7, wherein any service owned by the calling party in an established call is executed prior to any service owned by a called party to that established call.
